(19) United States
(12) Patent Application Publication
(10) Pub. No.: US 2004/0147238 A1
(43) Pub. Date: Jul. 29, 2004

(54) ANALOG DEMODULATOR IN A LOW-IF RECEIVER

(76) Inventors: Shou-Tsung Wang, Tainan Hsien (TW); Chung-Chiang Ku, Hsin-Chu City (TW); En-Hsiang Yeh, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,966

(22) Filed: Jan. 28, 2004

(30) Foreign Application Priority Data
Jan. 29, 2003 (TW) 092102064

(51) Int. Cl. H04B 1/16

(52) U.S. Cl. 455/208; 455/205

(57) ABSTRACT

An analog demodulator used in a low IF receiver to down-convert a pair of quadratureIF signals and to perform image-rejection operations. The analog demodulator includes at least one first calibration apparatus and/or at least one second calibration apparatus so that the analog demodulator can reduce DC offset that would cause LO leakage in the low IF receiver by using the first calibration apparatus and/or the second calibration apparatus. The analog demodulator further includes a filtering device connected to a LO generator for removing the 3^{rd} and 5^{th} order harmonic components.

### BACKGROUND OF INVENTION

1. Field of the Invention

The invention relates to an analog demodulator used in a low-IF receiver, and more particularly, to an analog demodulator for removing local oscillator (LO) leakage and high-order harmonic components by utilizing DC offset calibration and filtering mechanisms respectively.

2. Description of the Prior Art

There are three major architectures of RF transceivers used in wireless communications systems. The first is the super heterodyne system having an advantage of high sensitivity in operation by utilizing an IF (intermediate frequency) stage to receive and transfer signals but having a disadvantage of high assembling cost and excessive space requirements due to using more discrete components such as IF SAW filters. The second is the direct conversion system, also referred to as the zero IF system, which directly down-converts a RF frequency to a base-band frequency without the IF stage; however, this architecture suffers from low sensitivity and too much noise. The third is the low IF system, also referred to as the near zero IF system, which when compared with the super heterodyne system, the difference is that the IF (intermediate frequency) range of the low IF system is much lower than that of the super heterodyne system, and the frequency processed by low IF stage even approximates the baseband frequency. It not only saves cost and space by removing discrete components, such as IF filters, but also provides sufficient sensitivity and low noise.

As mentioned above, applying the low IF architecture in receivers of a wireless communications system has considerable advantages and it is therefore widely used in many systems such as WLAN (wireless LAN), cellular telephones, and cordless telephones. In U.S. Pat. No. 5,751,249, “Radio transmission system and a radio apparatus for use in such a system,” Baltus et al. disclose adjusting the electromagnetic wave receiver of an antenna array by utilizing a phased-array radio apparatus and using a low IF receiver or a zero IF receiver in a radio transmission system to integrate the whole system easier and more complete. Additionally, the low IF architecture is also used in the bluetooth system. For example, in the International Analog VLSI Workshop, “A 2.4 GHz CMOS Low-IF Receiver,” 1999, Yi Lu et al., and in the Proceedings of the 11th VLSI/CAD Symposium, “An FH-SS GFSK Low-IF Receiver for Bluetooth,” 2000, Wei-Cheng Liao et al. both disclose an architecture for a Bluetooth system utilizing low IF converters for converting a RF frequency to a 1˜4 MHz low IF frequency and processing it as a base-band frequency.

Nowadays, in some low IF or very low IF receiver architectures, a digital radio processor is used for processing the signals, wherein the signals are converted by an analog-to-digital converter when received from an antenna. The low IF architecture removes some analog components at the cost of increasing the complexity to integrate the digital radio processor into the RF receiver. Furthermore, this architecture not only requires high bandwidth, high speed, and high-resolution analog-to-digital converters, but also increases demands for calculation capability of the digital radio processor, making it not easy to reduce the cost of the end products. Recently, the more popular method is the integration of the analog and digital processes in the low IF or very low IF receivers. For example, in IEICE Transaction of Communication: Broadband and flexible receiver architecture for software defined radio terminal using direct conversion and low-IF principle, Vol. E83-B, No. 6, pp. 1246-1253, H. Tsurumi et al. express analog system-selection/digital channel-selection (ASS/DCS)is now the most common method and also utilize analog processes to receive and transfer signals between systems of different standards, utilizing a digital process to select the channel of a specific system. Although the ASS/DCS concept is being used in some low IF or very low IF receivers, utilizing a digital process to perform the demodulation and image rejection is still the most common architecture. In U.S. Pat. No. 5,802,463, “Apparatus and method for receiving a modulated radio frequency signal by converting the radio frequency signal to a very low intermediate frequency signal,” Zuckerman et al. disclose architecture of a very low IF and a digital demodulator implementation used in WLAN and cordless telephones. In their design, the signal frequency of the very low IF approaches the base-band frequency. Additionally, Zuckerman et al. further add an image rejection mechanism to the system to maintain the quality of the downconverted signals. According to the prior art similar with the concept of U.S. Pat. No. 5,802,463, many patents utilizing a digital demodulator in a low IF receiver or a very low IF receiver have been issued. For example, Mostafa et al. in U.S. Pat. No. 6,373,422, “Method and apparatus employing decimation filter for down conversion in a receiver,” and Brown et al. in U.S. Pat. No. 6,366,622, “Apparatus and method for wireless communications,” both disclose utilizing an analog-to-digital converter (ADC in short) to convert a pair of quadrature signals to digital signals and then to execute image rejection and down-convert the digital signals. Some patents focus on image rejection digitally described using the digital architecture of low IF or very low IF. For example, in U.S. Pat. No. 6,330,290, “Digital I/Q imbalance compensation,” Glas et al. disclose utilizing a test signal and a compensation mechanism to compensate the phase and amplitude of a pair of quadrature signals in digital process and to fine tune the phase and amplitude of signals for image rejection. However, to integrate a digital demodulator into an analog RF receiver in prior art is more complex and has a problem of too much current consumption due to the ADC converter being necessary for the digital demodulator.

Utilizing an analog demodulator to implement the architecture of very low IF is already mentioned in “RF Integrated Circuits in Standard CMOS Technologies,” by Michiel Steyaert et al., and in IEEE Transactions on Circuits and Systems-II: Analog and Digital Signal Processing, vol. 45, No. 3, pp. 269-282, 1998, by Michiel Steyaert and Jan Crols. They further disclose that there are indeed some advantages of integrating analog mixing architectures with an analog RF receiver. In the Symposium on VLSI Circuits Digest of Technical Papers, “An Analog Integrated Polyphase Filter for a High Performance Low-IF Receiver,” pp. 87-88, 1995, Jan Crols, Michiel Steyaert et al. describe utilizing a phase locked apparatus such as a phase-locked loop (PLL) circuit for calibrating phase mismatch to improve related problems of all digital low IF or very low IF architectures.

Nowadays, utilizing an analog demodulator in low IF or very low IF receivers has drawn more attention due to the advantages of integration with analog transceivers and low current consumption. However, utilizing an analog demodulator to down convert radio frequency signals to very low intermediate frequency which approximates the base-band frequency tends to generate other problems, such as phase mismatch, DC offset, LO leakage, and high order harmonic components generated by a local oscillator signal generator, . . . etc.

### SUMMARY OF INVENTION

It is therefore an objective of the present invention to provide an analog demodulator and related method used in a low-IF receiver to solve the above-mentioned problems.

According to one embodiment of the present invention, the analog demodulator includes a receiving circuit for receiving in-phase IF (intermediate frequency) signals and quadrature-phase IF signals; at least one first calibration device for reducing DC components of the in-phase IF signals and the quadrature-phase IF signals; a reference source for providing a reference clock; a local oscillator signal generator electrically connected to the reference source for transferring the frequency of the reference clock to a predetermined frequency; and at least one mixer electrically connected to the local oscillator signal generator and the at least one first calibration device for processing the pair of quadrature signals.

Another objective of the present invention is to provide an analog demodulator used in a low-IF receiver, the analog demodulator includes a receiving circuit for receiving a pair of quadrature signals; a reference source for providing a reference clock; a local oscillator signal generator electrically connected to the reference source for lowering the frequency of the reference clock to a predetermined frequency; at least one mixer electrically connected to the local oscillator signal generator and the receiving circuit for respectively processing the pair of quadrature signals; and at least one second calibration device electrically connected to the corresponding mixer for erasing DC offset generated by the mixer.

Another objective of the present invention is to provide an analog demodulator with image-rejection capability in a low-IF receiver, the analog demodulator includes a receiving circuit for receiving a pair of quadrature IF (intermediate frequency) signals; a reference source for providing a reference clock; a local oscillator signal generator electrically connected to the reference source for transferring the frequency of the reference clock to a predetermined frequency; at least one mixer electrically connected to the local oscillator signal generator and a calibration device for processing the pair of quadrature signals; and a filtering device electrically connected to the local oscillator signal generator for reducing high-order harmonic components generated by the local oscillator signal generator.

An advantage of the present invention is that it reduces LO leakage after the analog demodulator receives the pair of quadrature signals by utilizing at least one calibration device for reducing the DC offset in the pair of quadrature signals.

Another advantage of the present invention is it reduces LO leakage after the analog demodulator receives the pair of quadrature signals by utilizing at least one DC offset calibration circuit for reducing the DC offset generated by the mixer.

Another advantage of the present invention is it reduces high order harmonic components generated by the local oscillator signal generator by utilizing at least one filtering device to maintain stability and accuracy of signals.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of the first embodiment of the analog demodulator according to the present invention.

FIG. 2 is a schematic diagram of the second embodiment of the analog demodulator according to the present invention.

FIG. 3 is a schematic diagram of an embodiment of the controllable current mirror of the DC offset calibration circuit of FIG. 2.

FIG. 4 is a schematic diagram of another embodiment of the controllable current mirror of the DC offset calibration circuit of FIG. 2.

FIG. 5 is a schematic diagram of the third embodiment of the analog demodulator according to the present invention.

FIG. 6 is a circuit diagram of a part of the analog demodulator of FIG. 5. FIG. 7 and FIG. 8 are additional embodiments of the circuit of FIG. 6.

FIG. 9 is a schematic diagram of the embodiment of FIG. 5 with a filtering device.

FIG. 10 is a schematic diagram of the fourth embodiment of the analog demodulator according to the present invention.

### DETAILED DESCRIPTION

In one embodiment, the analog demodulator is a second-stage analog demodulator used in a low IF receiver. In more details, there is a front-end stage in front of the analog demodulator, and a baseband stage after the analog demodulator. The front-end stage down-converts the received RF signals with RF frequency to low IF frequency, and passes the signals with low IF frequency to the analog demodulator. The analog demodulator of the embodiment receives the signals with low IF frequency, processes and further down-converts the signals with low IF frequency to baseband frequency. The baseband stage receives and demodulates the signals with baseband frequency in order to obtain the information contained in the received RF signals.

Utilizing an analog demodulator in a low IF receiver needs to overcome problems such as LO leakage caused by DC offset and high order harmonic components which generally deteriorates system efficiency, thus, the analog demodulator of the embodiment utilizes two DC offset calibration mechanisms and one filtering mechanism to solve the above-mentioned DC offset and high order harmonic problems.

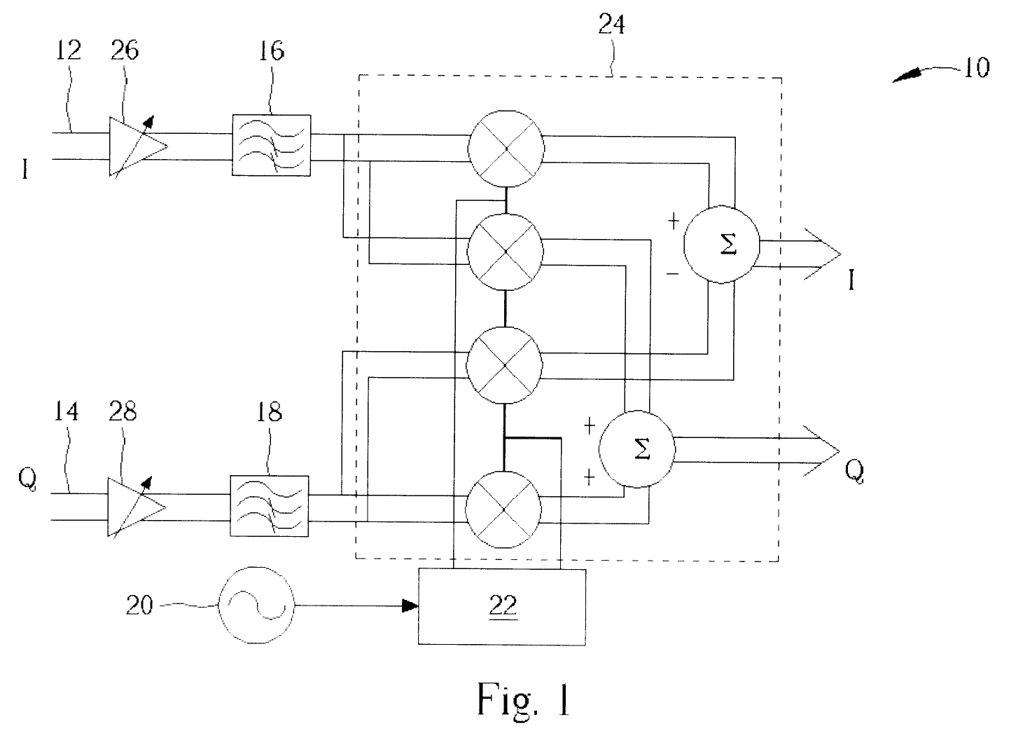

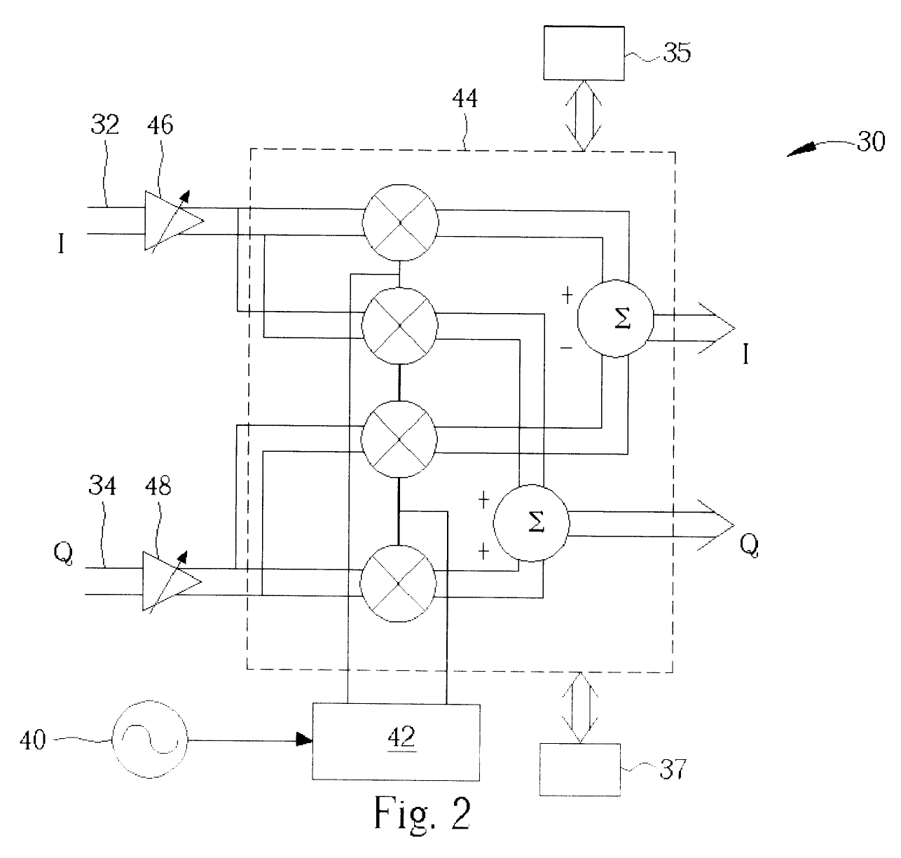

FIG. 1 illustrates a block diagram of the analog demodulator 10 according to the first embodiment of the present invention. The analog demodulator 10 is an image-rejected analog demodulator to perform image-rejected function. The analog demodulator 10 includes two receiving circuits 12, 14 for receiving a pair of quadrature IF(intermediate frequency) signals sent from the front-end stage (not shown in FIG. 1), the pair of quadrature IF signals including in-phase IF signal I and quadrature-phase IF signal Q respectively. As shown in FIG. 1, the analog demodulator 10 further includes calibration devices 16 and 18, a reference source 20, a local oscillator signal generator 22, and a mixer 24. The calibration devices 16 and 18 include a first calibration device 16 and a second calibration device 18 and are electrically connected to the receiving circuits 12 and 14 respectively. The in-phase IF signal I and the quadrature-phase IF signal Q pass through the calibration device 16 and the calibration device 18 respectively. Each of the calibration devices 16, 18 could be a notch filter or a high pass filter, or other devices that can reduce DC components of the in-phase IF signal I and/or the quadrature-phase IF signal Q. The calibration devices 16 and 18 in this embodiment are high pass filters with a very low cut off frequency used for filtering DC signals. Referring to FIG. 1, the first calibration device 16 corresponds to the in-phase IF signal 1, and the second calibration device 18 corresponds to the quadrature-phase IF signal Q. The in-phase IF signal I and the quadrature-phase IF signal Q are processed by the first calibration device 16 and the second calibration device 18 respectively and are then sent to the mixer 24. Additionally, the reference source 20 provides a reference clock to the local oscillator signal generator 22 and the local oscillator signal generator 22 transfers the frequency of the reference clock to a predetermined frequency. The range of the predetermined frequency may be selected between the RF frequency and the base-band frequency of the applications, such as a GSM cellular telephone or a WLAN system. The local oscillator signal generator 22 is electrically connected to the mixer 24 so that the mixer 24 can use the predetermined frequency to downconvert the in-phase IF signal I and the quadrature-phase IF signal Q into baseband signals. The processed in-phase IF signal I and the processed quadrature-phase IF signal Q are then sent to the baseband stage for further signal processing.

Referring to FIG. 1, the first embodiment of the present invention operates as follows. After the receiving circuit 12 and 14 receive the in-phase IF signal I and quadrature-phase IF signal Q respectively, as sent from a front-end stage (not shown in FIG. 1), the calibration devices 16 and 18 electrically connected to the in-phase IF signal I and quadrature-phase IF signal Q respectively reduce DC offset in the pair of input quadrature IF signals. The front-end amplifier circuit is the major cause of the DC offset, and the DC offset is the major cause of the LO leakage. The mixer 24 uses the predetermined frequency output from the local oscillator signal generator 22 to down-convert the in-phase IF signal I and the quadrature-phase IF signal Q and output the processed pair of quadrature IF signals I and Q. According to the first embodiment of the present invention, the analog demodulator 10 can further include a first programmable gain amplifier (PGA) 26 and a second PGA 28 respectively connected to the in-phase IF signal I and quadrature-phase IF signal Q respectively for amplifying the pair of quadrature IF signals I and Q. Since the analog demodulator 10 includes the first PGA 26 and the second PGA 28 for amplifying the pair of quadrature IF signals I and Q, if there is already some DC offset in the pair of quadrature IF signals I and Q sent from the front-end stage, after the first PGA and the second PGA amplifying the pair of quadrature IF signals, the magnitude of the final DC offset will become even more considerable. Without the first calibration device 16 and the second calibration device 18 to lower the DC offset in the pair of quadrature IF signals I and Q, the LO leakage caused by the considerable DC offset will greatly degrade system performance. Thus, having the two calibration devices 16 and 18 for the calibration function of DC offset in the pair of quadrature IF signals I, Q is one feature of the first embodiment of the present invention.

As mentioned above, the analog demodulator 10 is used in a low IF receiver applied in various applications, such as the GSM cellular phone or the WLAN system. Additionally, in practical implementations, the number of calibration devices is not necessarily limited to two. A single calibration device could also suffice. No matter whether a single calibration device or more than two calibration devices is used to implement the calibration function for the DC offset in the pair of quadrature IF signals, according to the same method, it should also be included in the embodiment.

Another source of DC offset in the system is device mismatch of the mixer core. FIG. 2 illustrates a schematic diagram of the second embodiment according to the present invention. The analog demodulator 30 is an image-rejected analog demodulator similar to the previous embodiment. The analog demodulator 30 includes two receiving circuits 32, 34, a reference source 40, a local oscillator signal generator 42, and a mixer 44. The two receiving circuits 32, 34 are used for receiving a pair of quadrature IF signals sent from the above-mentioned front-end stage (not shown in FIG. 2), wherein the pair of quadrature IF signals includes an in-phase IF signal I and a quadrature-phase IF signal Q. As shown in FIG. 2, the mixer includes two circuits, a first DC offset calibration circuit 35 and a second DC offset calibration circuit 37, corresponding to the in-phase IF signal I and quadrature-phase IF signal Q respectively. Each of the DC offset calibration circuits 35, 37 can be a controllable current mirror for transforming the in-phase IF signal I and quadrature-phase IF signal Q from voltage signals into current signals and for adjusting the bias current of input stages of the mixer 44 to the same magnitude in order to reduce LO leakage generated by the mixer 44.

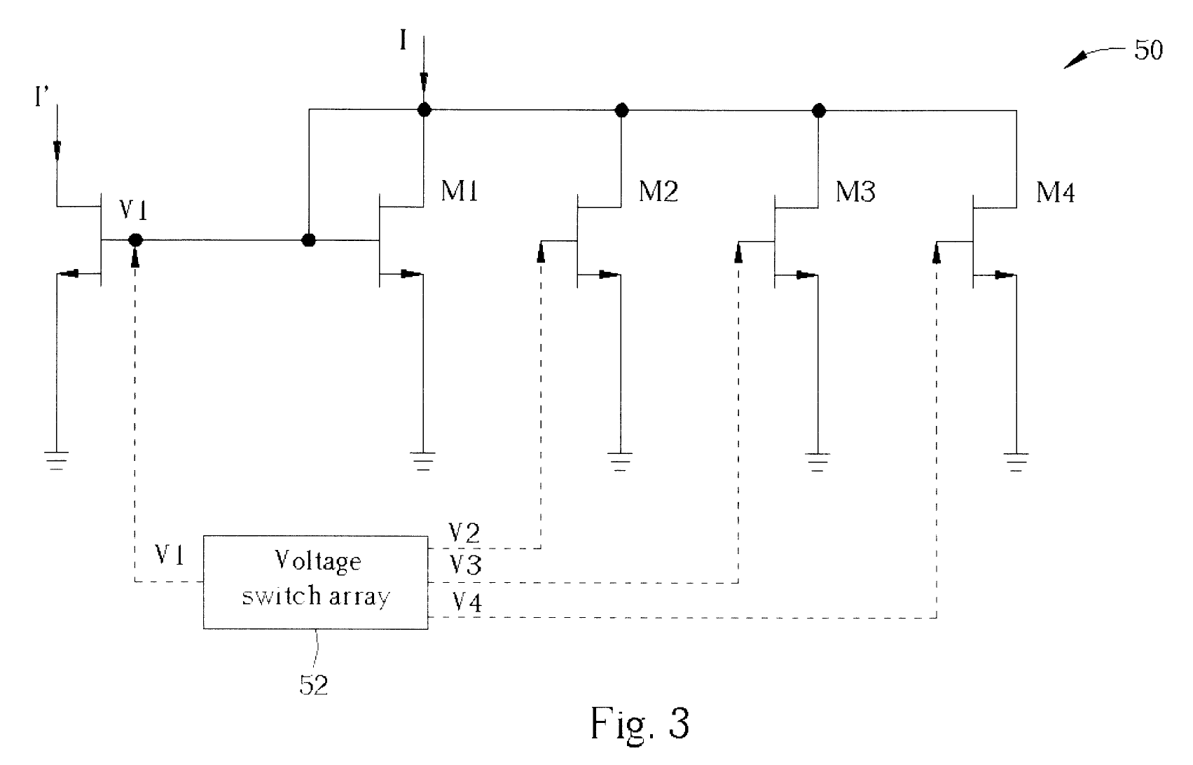

FIG. 3 shows an embodiment of the controllable current mirror of the first DC offset calibration device 35 and the second DC offset calibration device 37 of FIG. 2. As shown in FIG. 3, the controllable current mirror 50 can be implemented by utilizing metal-oxide semiconductor (MOS) transistors M1M4. The controllable current mirror of FIG. 3 shows the architecture of controlling the magnitude of current Ibut without the architecture of transforming voltage signals into current signals. As shown in FIG. 3, after the current I enters the controllable current mirror 50, the controllable current mirror 50 uses a voltage switch array 52 for controlling the switching voltages V1V4 corresponding to the MOS transistors M1M4 respectively to adjust the area of merged MOS transistors and thereby adjust the magnitude of the current I by changing the area of MOS transistors. In practical implementations, the number of MOS transistor is not limited as shown in the embodiment of FIG. 3. Generally speaking, the more MOS transistors used, the higher the accuracy of the adjustment.

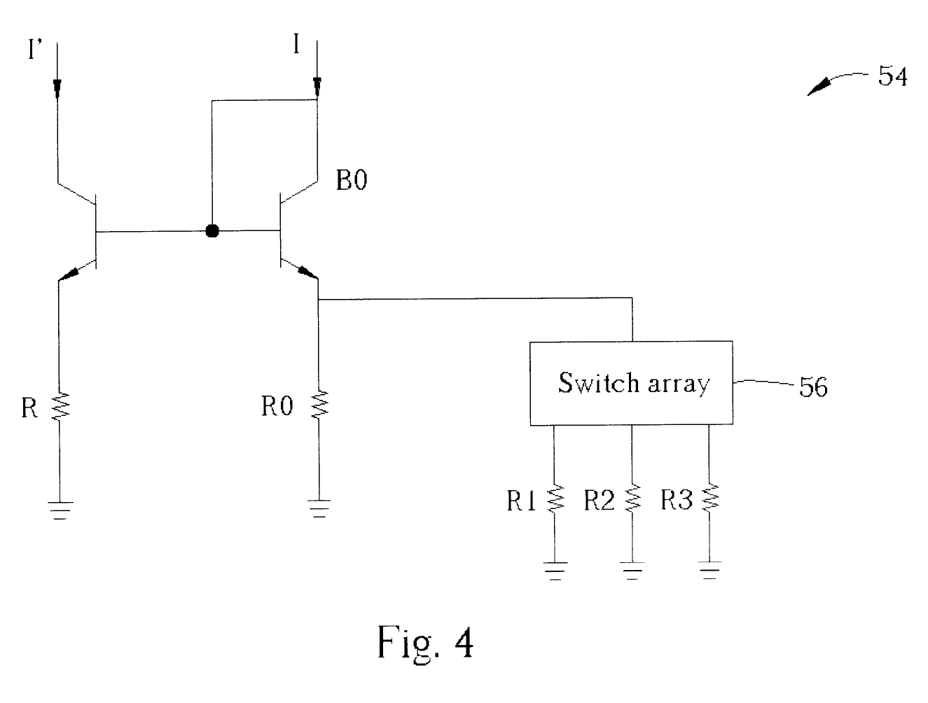

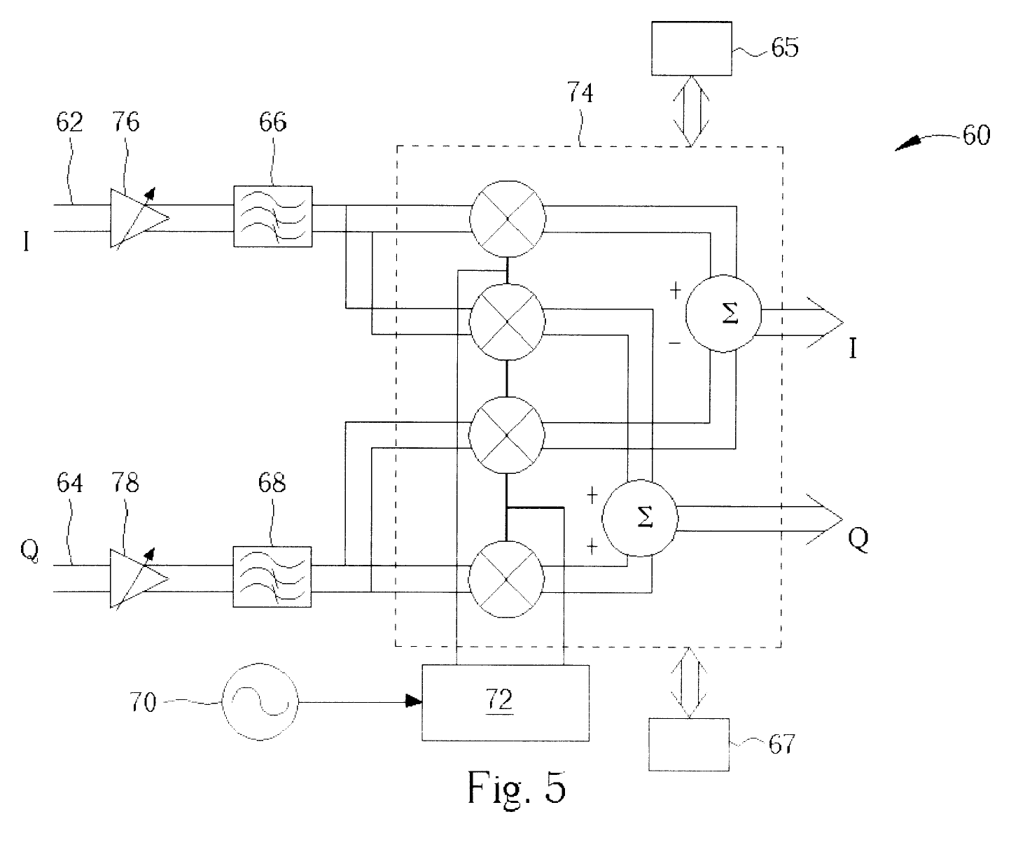

Referring to FIG. 4. FIG. 4 is another embodiment of the controllable current mirror of the DC offset calibration circuit of FIG. 2. The controllable current mirror 54 of FIG. 4 can be implemented by utilizing a bipolar transistor B0 and resistors R0R3. Similar to the embodiment of FIG. 3, the controllable current mirror 54 shows the architecture of controlling the magnitude of current. As shown in FIG. 4, after the current I enters the controllable current mirror 54, the controllable current mirror 54 uses a switch array 56 for switching open and close the connection corresponding to the resistances R0R3, thereby adjusting the magnitude of the current I by changing the merged resistance. Similarly, in practical implementations, the number of resistors is not limited as shown in the embodiment. Generally speaking, the more resistors used, the higher the accuracy of the adjustment.

Referring back to FIG. 2. The reference source 40 provides a reference clock to the local oscillator signal generator 42. The local oscillator signal generator 42 transfers the frequency of the reference clock to a predetermined frequency. The range of the predetermined frequency can be selected between the RF frequency and the base-band frequency of the applications, such as a GSM cellular telephone or a WLAN system. The local oscillator signal generator 42 is electrically connected to the mixer 44 and provides the reference clock of the predetermined frequency to the mixer. The mixer 44 uses the reference clock of the predetermined frequency to process the in-phase IF signal I and the quadrature-phase IF signal Q and the processed in-phase IF signal I and processed quadrature-phase IF signal Q are then sent to the next stage circuit. Technical features of the second embodiment of the present invention are utilizing the DC offset calibration devices 35, 37 connected to mixer 44 to reduce the DC offset generated by the mixer, and thereby reducing the LO leakage caused by the DC offset. Additionally, according to the second embodiment of the present invention, the analog demodulator 30 further includes at least one amplifier electrically connected to the receiving circuits 32, 34. This is shown as the first PGA 46 and the second PGA 48 in FIG. 1 connected to the in-phase IF signal I and quadrature-phase IF signal Q for amplifying the in-phase IF signal I and quadrature-phase IF signal Q respectively.

Similar to the first embodiment, the analog demodulator 30 of the second embodiment is also used in a low If receiver, wherein the low IF receiver could be applied in various applications, such as a GSM cellular telephone or a WLAN system. Additionally, please note in practical implementations, the number of DC offset calibration circuits is not limited to two and it is not required to include a DC offset calibration circuit on both the in-phase IF signal I path and the quadrature-phase IF signal Q path. That is to say, if the DC offset generated by the mixer could be reduced by a single DC offset calibration circuit on a path corresponding to either the in-phase signal IF I or quadrature-phase IF signal Q, this configuration should also be included in the embodiment.

Combining the technical features of the first embodiment and the second embodiment could better reduce the DC offset sent from the front-end stage or generated by the mixer, and therefore minimize the DC offset of the system and LO leakage caused by the DC offset. FIG. 5 is a block diagram of the third embodiment according to the present invention. An analog demodulator 60 of FIG. 5 combines technical features of the first embodiment and the second embodiment analog demodulators. The name and function of the related components are the same with the first and the second embodiments. The analog demodulator 60 includes two receiving circuits 62, 64 for receiving the in-phase IF signal I and quadrature-phase IF signal Q, two calibration devices 66, 68 (a first calibration device 66 and a second calibration device 68) for lowering the DC offset in the pair of quadrature IF signals, a reference source 70 for providing a reference clock, a local oscillator signal generator 72 for lowering the frequency of the reference clock to a predetermined frequency, a mixer 74 for processing the pair of quadrature IF signals, two DC offset calibration devices 65, 67 (a first DC offset calibration circuit and a second DC offset calibration circuit) for reducing the DC offset generated by the mixer. Technical features of the analog demodulator 60 of FIG. 5 are including two calibration devices 66, 68 electrically connected to the receiving circuits and two DC offset calibration circuits 65, 67 electrically connected to the mixer 74. In this way, all the sources of DC offset are considered so the DC offset which causes the LO leakage is minimized.

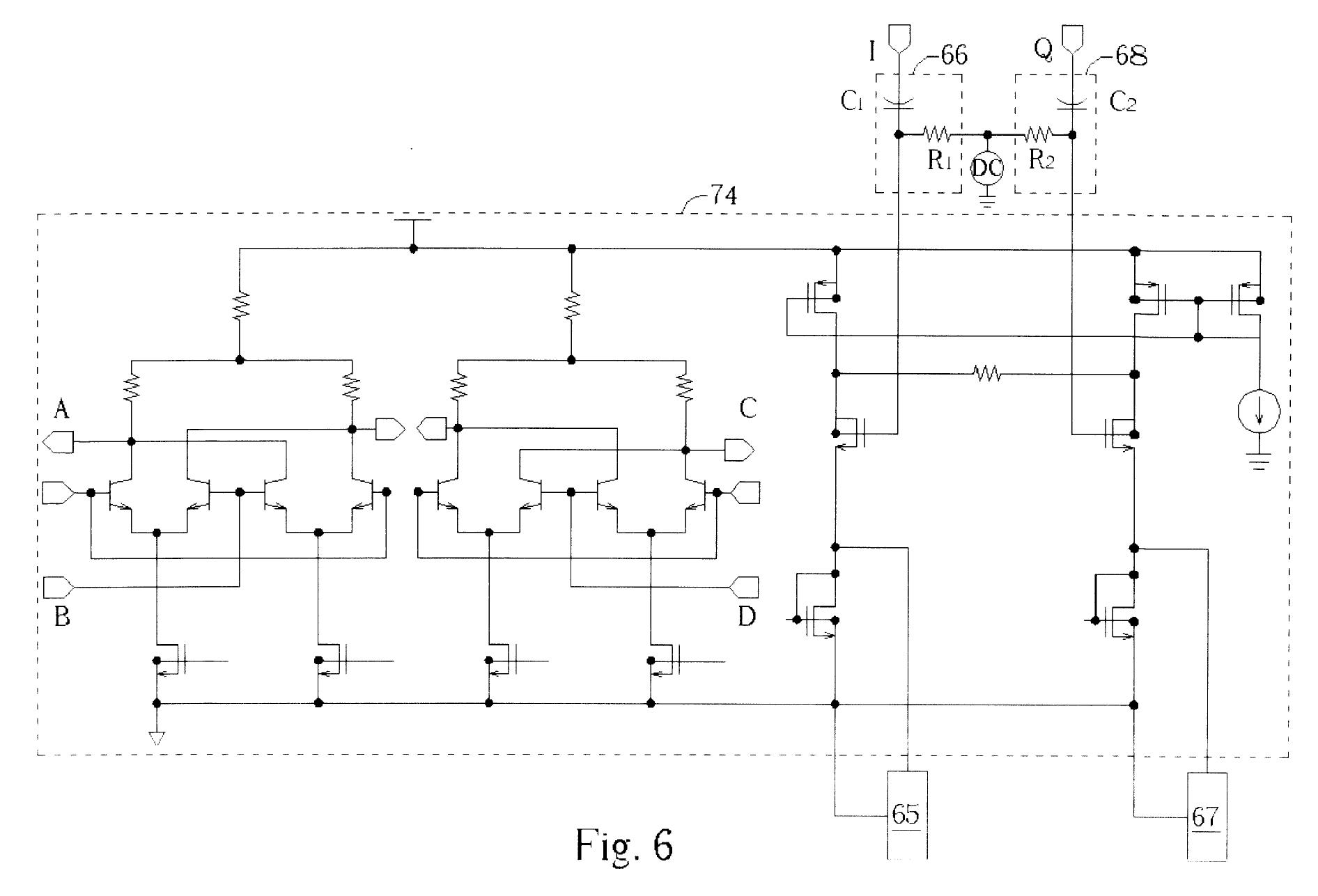

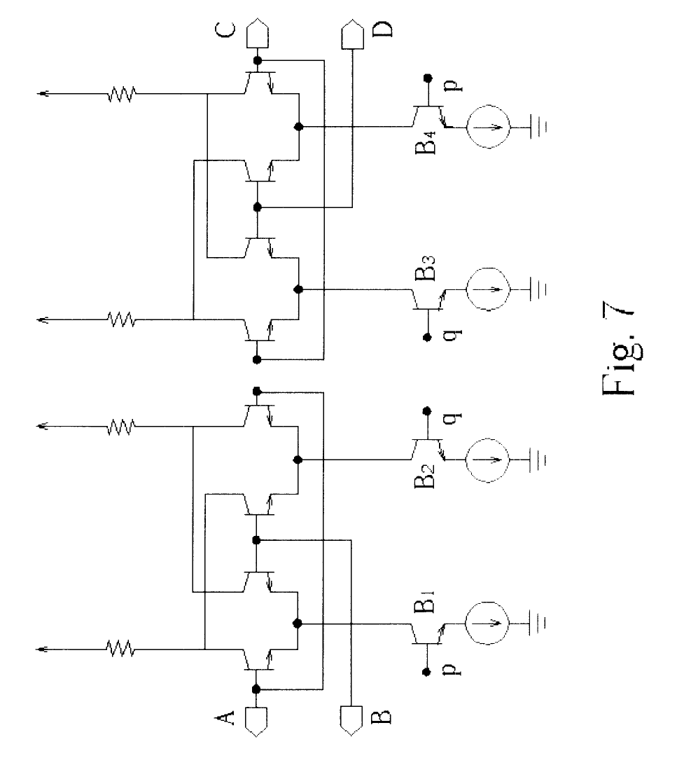

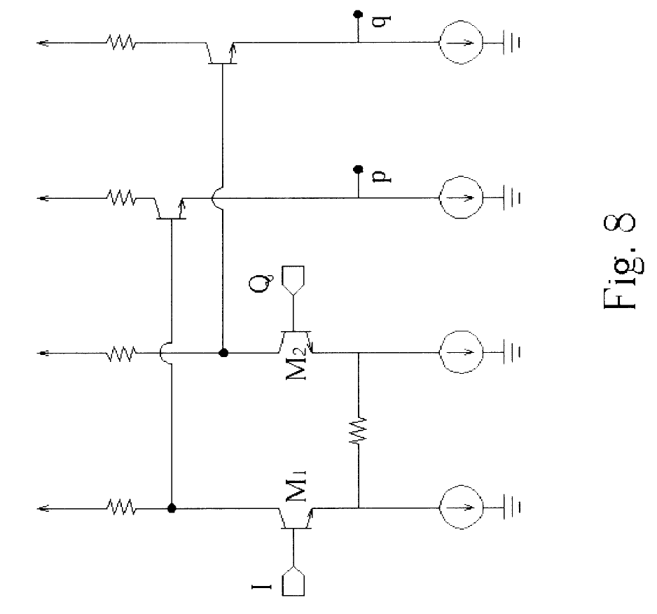

FIG. 6 is a circuit diagram of part of the analog demodulator 60 of FIG. 5. The circuit diagram of FIG. 6 is an embodiment of the analog demodulator 60 of FIG. 5 and the input signals are in the form of current signals. The circuit diagram of FIG. 6 includes two calibration devices 66, 68 (a first calibration device 66 and a second calibration device 68), mixer part 74, two DC offset calibration circuits 65, 67, and a local oscillator signal generator 72 of the analog demodulator 60 of FIG. 5. The circuit of the embodiment shown in FIG. 6 includes MOS transistors, bipolar transistors, and other analog components. Please note that, as shown in FIG. 6, the first calibration device 66 utilizes a notch filter having a resistance R1 and a capacitor C1, and the second calibration device 68 utilizes a notch filter having a resistance R2 and a capacitor C2 to reduce the DC offset. As mentioned above for the first embodiment, the type of the calibration device is not limited. A notch filter, high pass filter, or other devices that can calibrate DC offset should also be included in the embodiment. Furthermore, the type and the number of the DC offset calibration circuits are not limited either. Finally, since the analog demodulator 60 is an image-rejected analog demodulator according to the present invention, the image-rejection ability based on whether the quadrature phase difference among the four input ports A, B, C and D of the local oscillator signal generator 72 being 90 degrees and the amplitude of the four input signals received from the ports A, B, C and D being the same. FIG. 7 and FIG. 8 are another embodiments of the circuit shown in FIG. 6. Actually, FIG. 7 and FIG. 8 are connected to each other. The contacts P and Q of the circuit in FIG. 7 correspond to the contacts P and Q of the circuit in FIG. 8. Please also refer to FIG. 6. The architecture of FIG. 7 approximately corresponds with the mixer 74 of FIG. 6. The conditions that whether the quadrature phase difference among the input signals of the four ports A, B, C and D being 90 degrees and the amplitude of input signals of the four ports A, B, C and D being the same are also dominate the image-rejection ability of the analog demodulator 60. The architecture of FIG. 8 approximately corresponds with the circuit of FIG. 6 without the mixer 74, the two calibration devices (the first calibration device 66 and the second calibration device 68) and the two DC offset calibration circuits 65, 67. Thus the pair of quadrature IF signals I, Q shown in FIG. 8 should be regarded as processed by two calibration devices 66, 68 of FIG. 6. Please note that the major difference between FIG. 7, FIG. 8, and FIG. 6 is that the input signals are in the form of voltage signals in FIG. 7 and FIG. 8, but are in the form of current signals in FIG. 6. Furthermore, the MOS transistors M1, M2 and the bipolar transistors B1B4 of the embodiment of FIG. 7 and FIG. 8 are not limited in such combination, other architectures that can implement the same function should also be included in the embodiment.

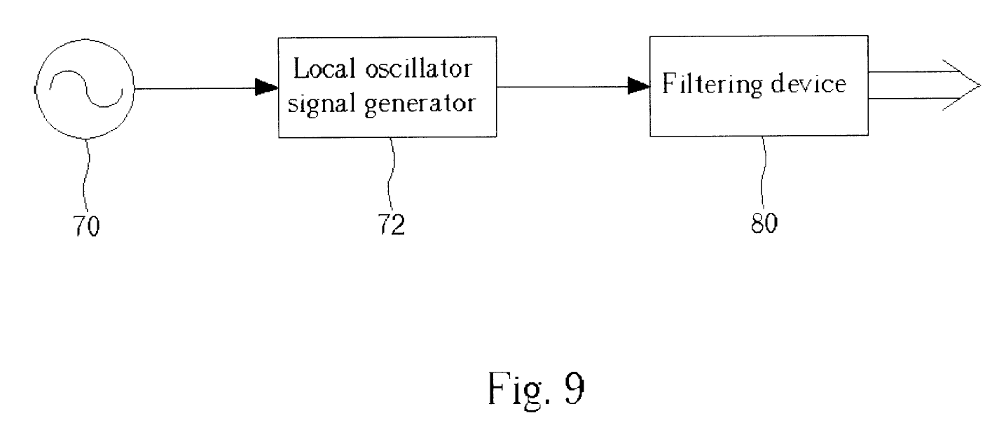

Under the analog demodulator architecture of the present invention, the problem needed to overcome not only includes the LO leakage caused by the DC offset, but also high order harmonic components may degrade system performance. As in the first through the third embodiments of the present invention mentioned above, since the reference clock provided by the reference source is a square wave signal and consists of different order harmonic components, problems with high order harmonic components easily occur. In the architecture of the first through the third embodiments, a filtering device could be configured after the reference source and the local oscillator signal generator to filter high order harmonic components, especially the 3^{rd} and 5^{th} order harmonic components, generated by the local oscillator signal generator. FIG. 9 is a schematic diagram of a local oscillator signal generator 72 of FIG. 5 with a filtering device 80 for filtering the 3^{rd} and 5^{th} order harmonic components. Please note that the filtering device 80 can be a poly-phase filter, a low pass filter, or a digital filter. The architecture of the schematic diagram of FIG. 9 is based on FIG. 5. In fact, the filtering device is also supported in the embodiments of FIG. 1 and FIG. 2.

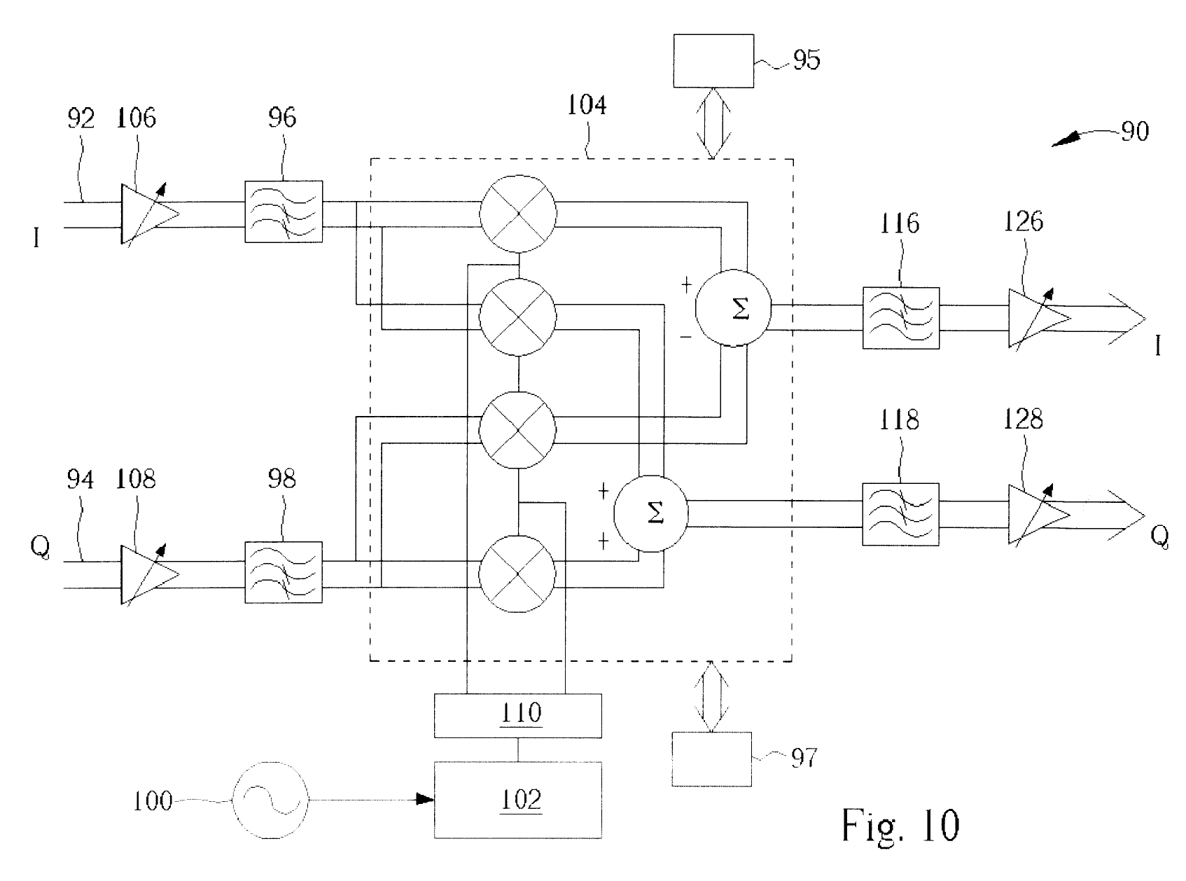

Thus, by combining the embodiments of FIG. 1, FIG. 2, FIG. 3, and FIG. 9, the technical features of these embodiments can be briefly summarized. FIG. 10 illustrates a block diagram of the fourth embodiment of an analog demodulator 90 according to the present invention. The fourth embodiment includes the main components and functions of all the above-mentioned embodiments. As shown in FIG. 10, the analog demodulator 90 includes two receiving circuits 92, 94, two calibration devices 96, 98 (a first calibration device 96 and a second calibration device 98), a reference source 100, a local oscillator signal generator 102, a mixer 104, a filtering device 110, and two DC offset calibration circuits 95, 97. The analog demodulator 90 further includes two amplifiers 106, 108 electrically connected to the receiving circuits 92, 94 for amplifying the received pair of quadrature IF signals I, Q. The analog demodulator 90 also further includes two amplifiers 126, 128 electrically connected to the output ports of the pair of quadrature IF signals I, Q for amplifying the processed pair of IF quadrature signals I, Q. The embodiment further includes two low pass filters 116, 118 electrically connected to the output ports of the mixer 104 for further reducing high order harmonic components generated by the front-end stage. When the receiving circuits 92, 94 receives the pair of IF quadrature signals I, Q respectively sent form the front-end stage, the calibration devices 96, 98 lower the DC offset in the pair of IF quadrature signals I, Q. Next, the filtering device 110 reduces the high order harmonic components generated by the local oscillator signal generator and the DC offset calibration circuits reduces DC offset generated by the mixer 104 when the mixer 104 and the local oscillator signal generator 102 process the pair of quadrature IF signals I and Q. Finally, the processed pair of quadrature IF signals I, Q are thereby outputted.

The present invention provides an analog demodulator used in a low IF receiver or a very low IF receiver for implementing the advantages of integration with an analog transceiver and low energy consumption. Furthermore, the present invention utilizes a calibration device, a DC offset calibration circuit, and a filtering device for performing DC offset calibration and filtering to solve problems such as DC offset and high order harmonic components caused by an analog demodulator used in a low IF receiver.

Those skilled in the art will readily observe that numerous modifications and alterations of the device may be made while retaining the teachings of the invention. Accordingly, that above disclosure should be construed as limited only by the metes and bounds of the appended claims.

1. An analog demodulator used in a low-IF receiver, the analog demodulator comprising:
a receiving circuit for receiving in-phase IF (intermediate frequency) signals and quadrature-phase IF signals;
at least one first calibration device for reducing DC components of the in-phase IF signals and the quadrature-phase IF signals;
a reference source for providing a reference clock;
a local oscillator signal generator electrically connected to the reference source for transferring the frequency of the reference clock to a predetermined frequency; and
at least one mixer electrically connected to the local oscillator signal generator and the at least one first calibration device for processing the pair of quadrature signals.

2. The analog demodulator of claim 1, wherein each of the first calibration devices comprises a notch filter or a high pass filter.

3. The analog demodulator of claim 1 further comprising at least one second calibration device electrically connected to the corresponding mixer for reducing DC offset generated by the mixer.

4. The analog demodulator of claim 3, wherein each of the second calibration devices comprises a controllable current mirror, wherein the controllable current mirror is used to transform the in-phase IF signals and the quadrature-phase IF signals into corresponding current signals and to adjust a bias current in an input circuit of the mixer equal to the corresponding current signals for reducing LO leakage generated when the in-phase IF signal and the quadrature-phase IF signal pass the mixer.

5. An analog demodulator used in a low-IF receiver, the analog demodulator comprising:
a receiving circuit for receiving a pair of quadrature signals;
a reference source for providing a reference clock;
a local oscillator signal generator electrically connected to the reference source for lowering the frequency of the reference clock to a predetermined frequency;
at least one mixer electrically connected to the local oscillator signal generator and the receiving circuit for respectively processing the pair of quadrature signals; and
at least one second calibration device electrically connected to the corresponding mixer for erasing DC offset generated by the mixer.

6. The analog demodulator of claim 5, wherein each of the second calibration devices comprises a controllable current mirror, wherein the controllable current mirror is used to transform the pair of quadrature signals into corresponding current signals and to adjust a bias current in an input circuit of the mixer equal to the corresponding current signals for erasing LO leakage generated when the pair of quadrature signals pass the mixer.

7. The analog demodulator of claim 5 further comprising at least one first calibration device for reducing DC components of the in-phase IF signals and the quadrature-phase IF signals.

8. The analog demodulator of claim 7, wherein each of the first calibration devices comprises a notch filter or a high pass filter.

9. An analog demodulator used in a low-IF receiver, the analog demodulator being an image-rejected analog demodulator with image-rejection capability, the analog demodulator comprising:
a receiving circuit for receiving a pair of quadrature IF (intermediate frequency) signals;
a reference source for providing a reference clock;
a local oscillator signal generator electrically connected to the reference source for transferring the frequency of the reference clock to a predetermined frequency;
at least one mixer electrically connected to the local oscillator signal generator and a calibration device for processing the pair of quadrature signals; and
a filtering device electrically connected to the local oscillator signal generator for reducing high-order harmonic components generated by the local oscillator signal generator.

10. The analog demodulator of claim 9, wherein the image-rejection ability of the analog demodulator relies on whether the quadrature phase difference among four input signals of the local oscillator signal generator is 90 degrees and whether amplitudes of the four input signals of the local oscillator signal generator are the same.

11. The analog demodulator of claim 9, wherein the filtering device is a poly-phase filter, a low pass filter, or a digital filter.
